(19) United States
(12) Patent Application Publication
(10) Pub. No.: US 2016/0232628 A1
(43) Pub. Date: Aug. 11, 2016

(54) REAL ESTATE BROKERAGE METHOD AND SYSTEM

(71) Applicant: Dean Arthur WITALA, Kelowna (CA)

(72) Inventor: Dean Arthur WITALA, Kelowna (CA)

(21) Appl. No.: 15/017,012

(22) Filed: Feb. 5, 2016

Related U.S. Application Data
(60) Provisional application No. 62/113,205, filed on Feb. 6, 2015.

(51) Int. Cl. G06Q 50/16; G06Q 30/06

(52) U.S. Cl. CPC G06Q 50/167; G06Q 30/0617

(57) ABSTRACT

A method of real estate brokerage is provided, the method comprising: identifying a client, the client owning a property; identifying a lawyer representing the client; identifying a real estate agent representing the client; defining a division of a commission payable on sale of the property between the lawyer and the real estate agent; marketing and/or promoting the sale of the property by at least one of the lawyer and the real estate agent based on the division of the commission; negotiating a sale/purchase contract; conveying the property to a buyer by the lawyer; and distributing the commission between the lawyer and the real estate agent according to the division. A non-transitory computer-readable medium storing instructions to perform a method of real estate brokerage is also provided.

### CROSS REFERENCE TO RELATED APPLICATIONS

This application is related and claims priority to US Provisional Patent Application Ser. No. 62/113,205 filed Feb. 6, 2015 and entitled “Real Estate Brokerage Method and System”, which is hereby incorporated herein by reference in its entirety for all purposes.

### TECHNICAL FIELD

The present invention relates to a method and system of real estate brokerage for lawyers and real estate agents to allocate responsibility and remuneration for a real estate sale and/or purchase transaction. More specifically, the present invention relates to a method of real estate brokerage for lawyers and real estate agents to determine a remuneration division structure to divide a commission from a real estate transaction and to divide tasks and responsibilities associated with a real estate transactions based on the commission division structure.

### BACKGROUND OF THE INVENTION

The purchase and sale of real estate and/or businesses (hereinafter referred to as “property”) typically involves a complex and involved transaction. In a transaction to sell property sellers typically have to: list and market the property, determine an asking price, negotiate the sale price, review terms in an offer for purchase and sale, provide for and complete condition of sale terms, attend to the legal conveyancing for transfer of the property to the purchaser, etc. Similarly, in a transaction to purchase property, purchasers may typically have to: determine a list of potential properties, research information about the neighbourhoods of potential properties (i.e. school, growth potential, crime rate etc.), negotiate the purchase price, draft an offer for purchase and sale agreement, obtain financing, review and execute conveyance or other transfer documents, etc. For both the purchaser and seller, a property transaction is typically a complex process that involves large sums of money, stringent legal requirements and the potential for costly mistakes.

Two professional industries exist to help both purchasers and sellers in their acquisition and sale of property. Real estate agents (also often referred to as REALTORS®) are available to aid in the marketing and advertising of the property for sellers, and advise purchasers of properties available for sale. Real estate lawyers (also interchangeably referred to as attorneys or lawyers) are typically available to aid in the review of legal documents, such as an offer for sale and purchase (if consulted by a purchase or seller or real estate agent), and assist in the completion of the conveyance of a property from a seller to the purchaser. In some cases, and in certain states, the closing of a real estate transaction may also involve licensed escrow agents and title companies. It is also possible for the foregoing functions to be conducted by real estate lawyers.

A real estate agent's business model may typically be based on the realtor developing systems to consistently obtain clients and generate property listings. Referrals from other individuals are often the most highly regarded and preferred business a real estate agent can obtain. The most successful real estate agents typically have thriving referral networks from their own network of contacts or contact database (i.e. past and current clients, friends and family). However, typically not many real estate agents enjoy steady referrals from one particular individual or entity. Therefore there remains a need for methods and systems that allow real estate agents to expand their sources of referrals.

It is not uncommon for law firms and lawyers, particularly those with a real estate and/or estates practice, to require professional services provided by a real estate agent on behalf of their clients. For example, in an estate sale, a lawyer may want, or be required, to hire a real estate agent to help advertise and promote a property for sale. In a conventional real estate transaction, described in detail below, the lawyer's involvement prior to the property's conveyance may be minimal. In addition, the lawyer may not typically be able to receive a portion of the commission in the sale of the property. Instead, the lawyer may typically charge a professional legal services and/or conveyancing fee directly to the property seller or client in addition to the commission typically paid by the seller to the real estate agent on the sale of the property.

Accordingly, there remains a need for methods and systems to provide for lawyers, in particular real estate lawyers, and real estate agents to facilitate and govern cooperative action between the lawyer and real estate agent for a client from the beginning of a property transaction, including a timely review of a legally binding contract by the lawyer, and preferably at no additional cost to the client.

### SUMMARY OF THE INVENTION

It is an object of the present invention to provide a method and system to allocate responsibilities between lawyers and realtors acting cooperatively, and to divide commission remuneration for a property transaction that address some of the limitations of the prior art.

According to one embodiment of the present invention, a method of real estate brokerage is provided, the method comprising: identifying a client, the client owning a property; identifying a lawyer representing the client; identifying a real estate agent representing the client; defining a division of a commission payable on sale of the property between the lawyer and the real estate agent; promoting the sale of the property by at least one of the lawyer and the real estate agent based on the division of the commission; conveying the property to a buyer by the lawyer; and where applicable, with the assistance of escrow and/or title company agents, and distributing the commission between the lawyer and the real estate agent according to the division.

According to another embodiment of the invention, a further method of real estate brokerage is provided, the method comprising: identifying a client, the client purchasing a property; identifying a lawyer representing the client; identifying a real estate agent representing the client; defining a division of a commission payable on purchase of the property between the lawyer and the real estate agent; showing the property by at least one of the lawyer and the real estate agent based on the division of the commission; conveying the property to the client by the lawyer, and where applicable with the assistance of escrow and/or title company agents; and distributing the commission between the lawyer and the real estate agent according to the division. In a further embodiment of the invention, a non-transitory computer-readable medium storing computer-executable instructions to implement a method of real estate brokerage is provided. In one such embodiment, the computer-readable medium comprises computer-executable instructions to: identify a client, the client owning or purchasing a property; identify a lawyer representing the client; identify a real estate agent representing the client; define a division of a commission payable on at least one of sale or purchase of the property between the lawyer and the real estate agent; promote or show the property by at least one of the lawyer and the real estate agent based on the division of the commission; convey the property to a buyer of the property by the lawyer; and distribute the commission between the lawyer and the real estate agent according to the division.

In a particular such embodiment, the computer-executable instructions to identify a lawyer representing the client comprise instructions to generate a retainer agreement document and recording execution of the retainer agreement document. In another such embodiment, the computer-executable instructions to identify a real estate agent representing the client comprise instructions to generate an engagement agreement document and recording execution of the engagement agreement document.

Further advantages of the invention will become apparent when considering the drawings in conjunction with the following detailed description.

### BRIEF DESCRIPTION OF THE DRAWINGS

The present invention will now be described with reference to the accompanying drawing figures, in which:

FIG. 1 is a schematic relationship diagram illustrating the stakeholders involved in a property transaction for the sale of a property, in accordance with an aspect of a prior art real estate relationship model.

FIG. 2 illustrates an exemplary series of operations associated with an aspect of a prior art conventional real estate transaction model.

FIG. 3 is a schematic relationship diagram illustrating the stakeholders involved in a property transaction for the sale of a property in accordance with an embodiment of the invention.

FIG. 4 illustrates an exemplary series of operations associated with the sale of a property in accordance with an embodiment of the invention.

FIG. 5 is a relationship diagram illustrating the stakeholders involved in a property transaction for the purchase of a property in accordance with an embodiment of the invention.

FIG. 6 illustrates an exemplary series of operations associated with the purchase of a property in accordance with an embodiment of the invention.

Like reference numerals refer to corresponding parts throughout the several views of the figures.

### DETAILED DESCRIPTION OF THE PREFERRED EMBODIMENTS

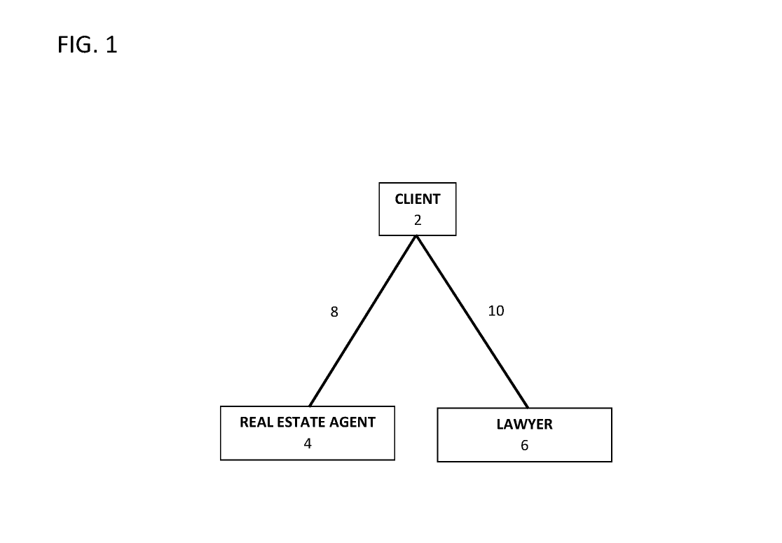

FIG. 1 is a relationship diagram depicting a seller client 2, a real estate agent 4 and a lawyer 6 according to an aspect of a prior art conventional real estate transaction model. Client 2, is an individual, corporation or otherwise legal or equitable entity seeking to sell a property. Client 2 forms an agency relationship 8 with a real estate agent 4 by executing an agency contract, such as a typical listing agreement whereby the real estate agent is contracted to act as the seller client's agent to list and advertise the seller's property for sale. The client 2 may also typically enter into a separate attorney-client relationship 10 with a real estate or conveyancing lawyer 6 to convey the property after a sale agreement is entered into with a buyer by entering into a separate retainer agreement with the lawyer 6. Typically, in a conventional business model, the client 2 would need to locate and contract with the real estate agent 4 and lawyer 6 separately, and may typically not even retain the lawyer 6 until after a sale agreement is negotiated or entered into by the client 2.

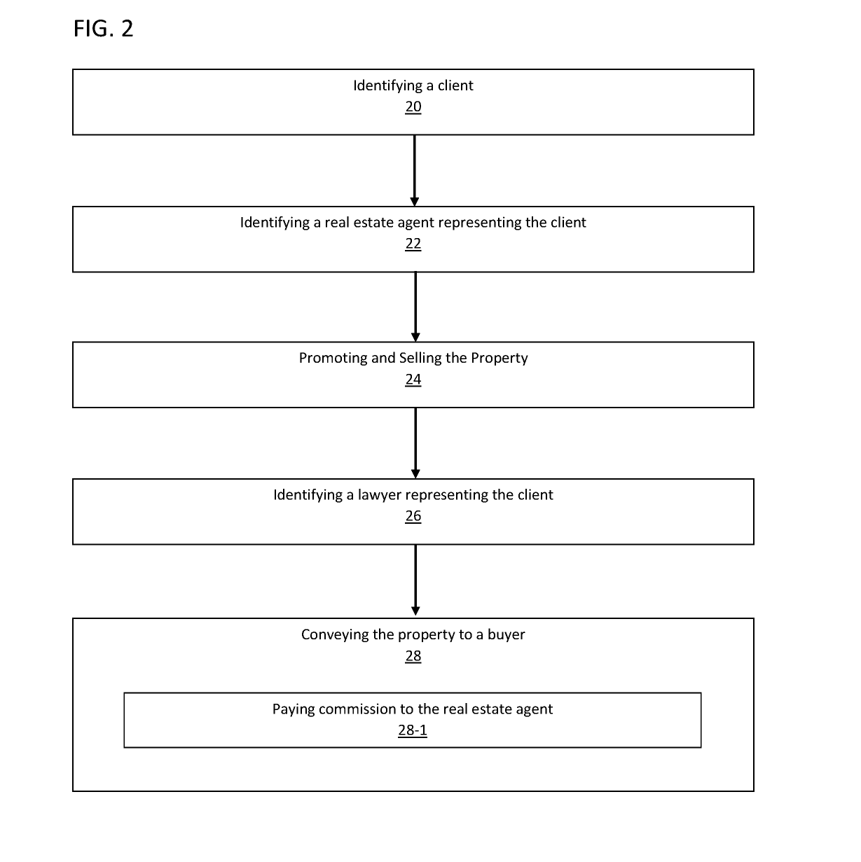

FIG. 2 illustrates a series of operations that may typically be completed during a conventional real estate transaction. The first operation 20 of FIG. 2 comprises identifying a client 2 that wishes to sell a property.

The second operation 22 of FIG. 2 comprises identifying a real estate agent 4 to represent client 2. In the second operation 22, client 2, through advertisements, family, friends or past experience may select a real estate agent 4 to help in the sale of client's 2 property. Client 2 and real estate agent 4 will, among other tasks, typically negotiate the commission to be paid to real estate agent 4 upon successful sale of the property. In some jurisdictions, an industry standard typically provides for a commission of approximately 6% of the sale price of the property to be paid to the real estate agent 4 as the commission. In addition to negotiating and agreeing to a commission, client 2 and real estate agent 4 may typically outline the tasks real estate agent 4 will complete in association with the sale of the property. An exemplary and series of tasks which the real estate agent 4 may agree to be performed in association with the sale of a property may include: promoting the property through advertisements such as posting on MLS® or another listing service or publication promoting the property through real estate agent's personal and professional network, conducting open houses, showing the property to prospective purchasers, representing client 2 in negotiations with prospective purchasers, reviewing and advising on offers for sale and purchase of the property, receiving deposit money, contact with clients providing feedback from property showings, providing market updates to clients and providing primary client contact availability to manage client expectations, questions and emotions, for example. To formalize the agency relationship 8 to have the real estate agent 4 represent the client 2, client 2 and real estate agent 4 may execute a listing agreement or other suitable agency agreement or contract defining the services to be provided by the real estate agent 4 in representing the client 4.

The third operation 24 of FIG. 2 comprises promoting the property by the real estate agent 4. Promoting the property may typically comprise performing the series of tasks that real estate agent 4 agreed to in the second operation 22. In a conventional property sale transaction, the third operation 25 is typically completed when client 2 has an executed purchase and sale agreement with a purchaser. At such stage in a conventional business model, the purchase and sale agreement is typically ready for conveyancing to transfer ownership to a purchaser.

The fourth operation 26 of FIG. 2 comprises identifying a lawyer 6, or law firm, to represent client 2. Client 2, such as through the referral of real estate agent 4, advertisements, family, friends or past experiences, typically selects lawyer 6 to complete the conveyance of the client's 2 property. Client 2 and lawyer 6 may typically negotiate a professional service fee for the lawyer's assistance completing the conveyance. In some jurisdictions a professional fee charged for conveyancing or legally transferring a property from seller to buyer may typically be approximately $600-$1500 for a simple conveyance of a residential property, for example. To formalize the attorney-client relationship 10, client 2 and lawyer 6, may typically execute a retainer agreement or other suitable professional representation agreement, for example.

The fifth operation 28 of FIG. 2 comprises conveying the property to a purchaser. In general, conveying the property to the buyer or purchaser may in some jurisdictions typically comprise: reviewing the purchase and sale agreement, reviewing a property disclosure statement (if any), searching and reviewing title of the property, providing undertakings, depositing purchase funds into trust, filing appropriate forms one or more land title offices, paying disbursements, preparing a statement of account, and paying the remainder of the funds to the selling client 2. The fifth operation may typically further comprise the operation 28-1 of paying commissions to the real estate agent. Such commission may typically be divided between the client's real estate agent 4 and a real estate agent acting for the buyer, if any.

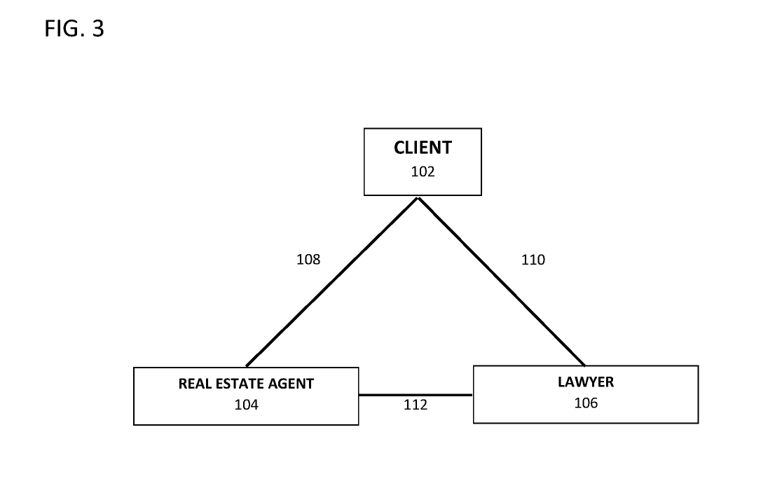

FIG. 3 is a relationship diagram depicting a seller client 102, real estate agent 104 and lawyer 106, in accordance with an embodiment of the present invention. Client 102 may typically be an equivalent property seller to the seller client identified as client 2 in the conventional example illustrated in FIG. 1. In one aspect of the invention, client 102 enters into an attorney-client relationship 110 with lawyer 106. Attorney-client relationship 110 may desirably provide lawyer 106 with broad authority to supervise and assist in promotion and negotiation phases of the property sale and may further desirably define a commission based payment structure for compensation of the lawyer 106 upon completion of the sale of the property. Client 102 also enters into an agency relationship 108 with real estate agent 104. In one embodiment, agency relationship 108 may desirably provide that the fees associated with real estate agent 104's services will be paid upon sale of the property based on the fee set forth in the agency agreement entered into by client 102 with real estate agent 104. As shown in FIG. 3, lawyer 106 and real estate agent 104 enter into a relationship 112 for co-representation of the client 102. In one embodiment, relationship 112 may comprise an agreement, such as a written or electronically represented written agreement, defining a division of tasks involved in a property transaction and/or defining a division of commission remuneration between the lawyer 106 and real estate agent 104 upon sale of the property.

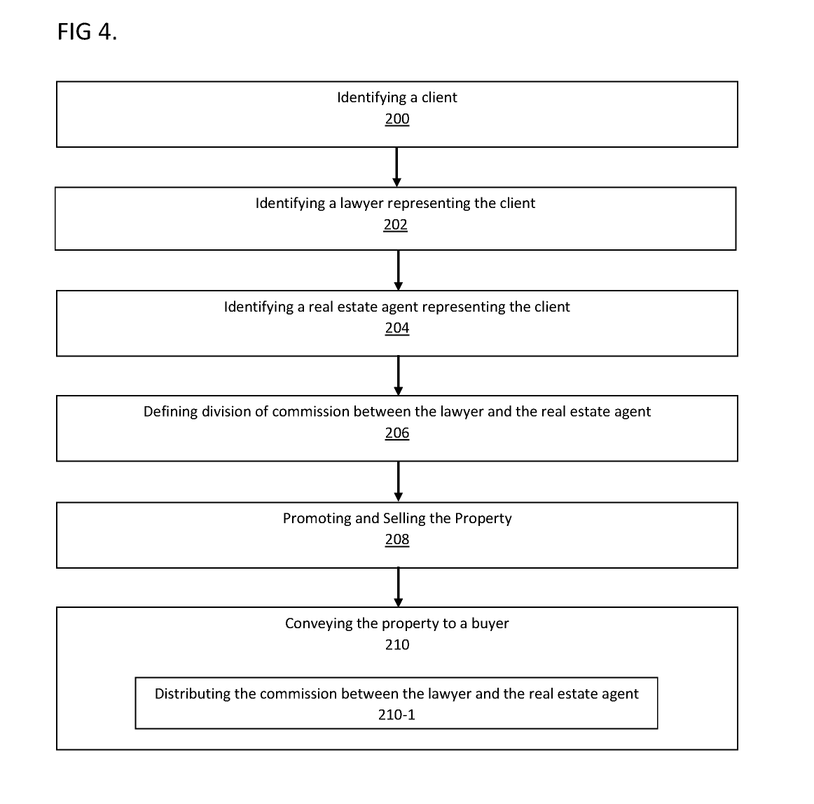

FIG. 4 illustrates an exemplary series of operations according to an embodiment of the present invention. The first operation 200 of FIG. 4 comprises identifying a client 102. In one embodiment, Client 102 is a seller that wishes to sell a property.

The second operation 202 of FIG. 4 comprises identifying a lawyer 106 representing client 102. Client 102 enters into an attorney-client relationship 110 with lawyer 106 to represent client 102. In one aspect of the invention, in forming relationship 110, client 102 may desirably retain and/or provide lawyer 106 with the authority to represent and act on behalf of client 102 for the purpose of taking all necessary and prudent steps to sell and transfer the property, including marketing, advertising, negotiating and acting on the client's 102 behalf with prospective purchasers and their lawyers or agents. In a preferred embodiment, client 102 may provide instructions that lawyer 106 may share its commission with a real estate agent 104 on the basis of a separate agency agreement (also commonly known as listing agreement) being entered into between real estate agent 104 and client 102. In one such preferred embodiment, client 102 may authorize lawyer 106 to permit real estate agent 104 to perform some of the tasks involved in selling the property such as marketing and advertising the property, showing the property to prospective buyers, and/or negotiating a sale contract for example. In some embodiments, lawyer 106 may be given the option to perform all the tasks involved in the property transaction alone without the help of a real estate agent 104. In one such embodiment, lawyer 106 may be retained to perform all the necessary tasks associated with sale of a property, such as promoting the property, negotiating a purchase agreement, and conveying the property to a purchaser, for example. Typically, operation 202 may desirably comprise executing a retainer agreement between the client 102 and lawyer 106 which defines the tasks to be completed in association with the sale of the property, and further defining the remuneration to be paid to the lawyer for such services.

In one such embodiment, operation 202 further comprises defining the remuneration to be paid by the client 102 for the provision of services by lawyer 106. In one such embodiment, client 102 may agree to pay lawyer 106 a portion of the proceeds in the sale of the property as a commission on the sale price of the property. The commission may be negotiated between lawyer 106 and client 102 and in one exemplary embodiment may typically range from 0-10% of the sale price of the property. In another exemplary embodiment, the commission may be approximately 3% of the sale price of the property.

In some embodiments, relationship 110 may desirably define that lawyer or law firm 106 may only exclusively represent one party in the transaction associated with the sale of the property. That is law firm 106 may only represent client 102, and may not form a relationship, such as a limited dual agency relationship, with a purchaser.

In some embodiments, relationship 110 may be formalized in the form of a retainer agreement, contract or other legal agreement, such as for example a written or electronically represented written agreement, between lawyer 106 and client 104. Accordingly, such retainer agreement may desirably define the agreed to terms and conditions of relationship 110 between the lawyer 106 and client 102, including the commission to be paid to the lawyer 106 for services associated with the sale of the property.

In some embodiments, client 102 may be already be represented by law firm 106. For example, client 102 may represent an estate as executor/trustee and law firm 106 may be retained to deal with the estate probate and disposition of the property. In another embodiment, law firm 106 may be a trustee and wishes to sell a property on behalf of its client beneficiaries 102. In another embodiment, law firm 106 may be acting for a foreclosing lender who wishes to liquidate a property owned by client 102.

The third operation 204 of FIG. 4 comprises identifying a real estate agent 104 representing client 102. In one embodiment, identifying a real estate agent 104 representing the client 102 comprises a client 102 and real estate agent 104 entering into an agency relationship 108, such as a written agreement or electronically represented written agreement, for example. In some embodiments, identifying real estate agent 104 may involve lawyer or law firm 106 searching a realtor database of realtors willing to form a relationship 112 with the lawyer 106. In some embodiments, client 102 may know a real estate agent 104 that is willing to engage in relationship 112 with the lawyer 106 for cooperatively providing services associated with sale of the property.

In one such embodiment, operation 204 further comprises defining the remuneration to be paid to the real estate agent for the provision of services in the sale of a property. In a preferred embodiment, real estate agent 104 agrees to be paid a portion of the total lawyer's 106 commission based on the amount set forth in the agency agreement between the real estate agent 104 and client 102. In one such embodiment, the division of the commission and amount to be paid to each of the real estate agent 104 and lawyer 106 is determined by the fourth operation 206 and is defined in the relationship 112 between the real estate agent 104 and lawyer 106.

In some embodiments, relationship 108 will provide that real estate agent 104 may only exclusively represent one party in the transaction associated with the sale of the property. That is, real estate agent 104 may only represent seller client 102, and may not form a relationship, such as a limited dual agency relationship, with a purchaser.

In some embodiments, client 102 and real estate agent 104 may formalize their agency relationship 108 such as by completing a listing agreement or other agency agreement, such as a written agreement or electronically represented written agreement, which defines the agreed to terms and conditions of agency relationship 108, such as for the purposes of listing and/or marketing a property, for example.

The fourth operation 206 comprises defining a division of commission between lawyer 106 and real estate agent 104. In some embodiments, such as where real estate agent 104 is involved in the property sale transaction, real estate agent 104 will share a portion of the commission paid to lawyer 106 such as to be divided in proportion with the responsibility of each of the real estate agent 104 and lawyer 106 for performing tasks associated with the property sale, and such division may be defined at operation 206. On one such embodiment, that portion of the commission payable to real estate agent 104 may be set forth in the agency agreement, and that portion of the commission payable to the lawyer 106 will be set forth in the retainer agreement.

In one embodiment, lawyer 106 and real estate agent 104 may negotiate and define a division of commission or commission sharing term forming the basis of relationship 112. In some embodiments, the division of commission or commission sharing term may comprise a fixed sum to be paid to one or more of the lawyer 106 and real estate agent 104. In some embodiments, the division of commission or commission sharing term may comprise a percentage of a total commission paid to lawyer 106 upon sale of the property and defined in relationship 110 between the lawyer 106 and client 102.

In some embodiments, a division of commission or commission sharing term may further comprise lawyer 106 and real estate agent 104 dividing a series of required tasks associated with the sale of the property between themselves. In one such embodiment, the division of tasks may be based on the division of the commission. In one embodiment, a non-limiting exemplary series of tasks associated with the sale of a property that may be divided between the lawyer 106 and real estate agent 104 may comprise:
Creating a market analysis report and determining asking price for the property;
Marketing the property, such as, taking photos and/or developing websites or advertisements;
Listing the property, such as, placing an MLS® or other listing for the property;
Showing the property to prospective purchasers, such as, conducting open houses, providing access to the property;
Reviewing a title document to the property;
Reviewing an offer for the sale and purchase of property from the prospective purchaser and advising the client 102 or negotiating a counter-offer; and
Receiving trust money from a prospective purchaser.

In some embodiments, the division of commission or commission sharing terms and corresponding relationship 112 may be restricted by legislation or regulation. In some jurisdictions, lawyer 106 may be limited to provide only legal services; in such jurisdictions, real estate agent 104 and lawyer 106 may agree to divide the tasks based on each party's legally permitted work, and may agree to a division of commission or commission structure reflecting the amount of work each party provides. In other jurisdictions where lawyers 106 may be permitted to provide real estate services, the division of tasks and commission may define that the real estate agent 104 may be hired for as little as exposure on MLS® or another property listing service, database, registry or other compilation of property information, for example. In one such embodiment, the division of commission or commission share payable to a real estate agent 104 may be defined to reflect a lesser amount of work being completed by real estate agent 104.

In one embodiment, lawyer 106 may perform the tasks of reviewing title upon commencement of listing a home for sale, receiving all correspondence between the real estate agent 104 and client 102, receiving and reviewing offers for sale and purchase of the property, and attending to the conveyance of the property. In an exemplary such embodiment, a division of commission to the lawyer 106 may comprise an approximately 30-40% share of the total commission. In one such embodiment, the remainder of the tasks associated with the sale of a property would be performed by the real estate agent 104, with the real estate agent receiving the remainder of the commission, approximately 60-70% of the total commission, for example.

In some embodiments relationship 112 may be formalized between lawyer 106 and real estate agent 104 through an engagement agreement, contract, and/or other legal document, such as in the form of a written agreement or an electronically represented written agreement, which may desirably define the division of commission and tasks between the lawyer 106 and real estate agent 104.

Although the second 202, third 204 and fourth 206 operations have been presented in a sequential order in the exemplary embodiment illustrated in FIG. 4, the order of each operation is non-essential to the practice of the invention. In other embodiments, each of operations 202, 204, 206 may occur before or after one another. In some embodiments, the operations 202, 204, 206 may commence concurrently. In some embodiments, the fourth operation 206 (defining division of commission) and relationship 112 may exist prior to client 102 deciding to sell their property and before the first operation 200.

The fifth operation 208 comprises promoting the property. In one embodiment, promoting the property may typically comprise lawyer 106 and real estate agent 104 performing the series of tasks that each previously agreed to in accordance with the fourth operation 206, in association with the sale of the property. The fifth operation 208 may typically be completed when client 102 has executed a purchase and sale agreement with a purchaser. In one embodiment, at such point the purchase and sale agreement may desirably be ready for conveyancing.

The sixth operation 210 comprises conveying the property to the purchaser. In one embodiment, conveying the property to the purchaser may typically comprise one or more of:
Reviewing title (if not previously completed);
Conducting searches, such as searches for any mortgages, taxes, liens, or other charges on title;
Preparing transfer documents, such as statements of adjustment, tax certificates, property transfer tax forms, for example;
Attending to the signing of documents by the purchaser;
Liaising with the seller's lawyer
Ordering funds from a lender (if any), deposit the balance of funds from the purchaser, and confirming excess deposit has been received;
Acting as escrow agent
Filing/recording the transfer documents such as in a land title registry or other property records office;
Arranging for title insurance and/or liaising with title companies;
Paying any existing mortgages, and discharging any other liens and liabilities for the property.

In some embodiments, fifth operation 210 may additionally comprise operation 210-1 which comprises distributing the commission between the lawyer 106 and the real estate agent 104. In one such embodiment, the commission may be distributed according to the division of commission or commission sharing terms defined in operation 206 as part of relationship 112 between the lawyer 106 and real estate agent 104. In one embodiment, either of operation 210 or 210-1 may additionally comprise paying the remainder of the purchase funds, following distribution of the commission, to the client 102 as proceeds of the sale of the property.

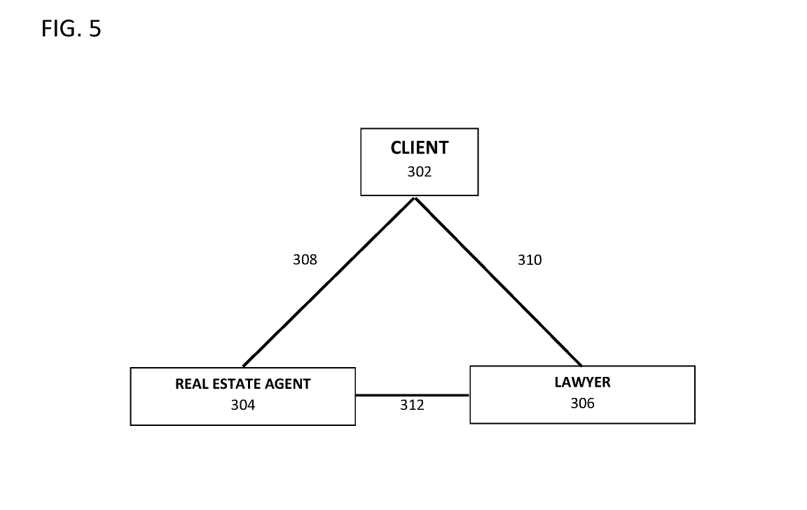

FIG. 5 is a schematic relationship diagram depicting a purchaser client 302, real estate agent 304 and lawyer 306, in accordance with an embodiment of the invention. Purchaser or buyer client 302 may typically be equivalent to client 102 except purchaser client 302 wishes to purchase rather than sell a property. In one aspect of the invention, client 302 enters into an attorney-client relationship 310 with lawyer 306. Relationship 310 is similar to relationship 110 except relationship 310 may desirably provide lawyer 306 with broad authority to supervise and aid in the purchase of a property and may further desirably define a commission based structure for compensation of the lawyer 306 from a commission paid by the seller of the property upon completion of the sale. Client 302 also enters into an agency relationship 308 with real estate agent 304. Agency relationship 308 is similar to agency relationship 108 except agency relationship 308 provides that real estate agent 304 will provide service associated with the purchase of a property. Lawyer 306 and real estate agent 304 enter into a relationship 312 for co-representation of the client 302, similar to relationship 112, except the division of commission and tasks are associated with the purchase of a property.

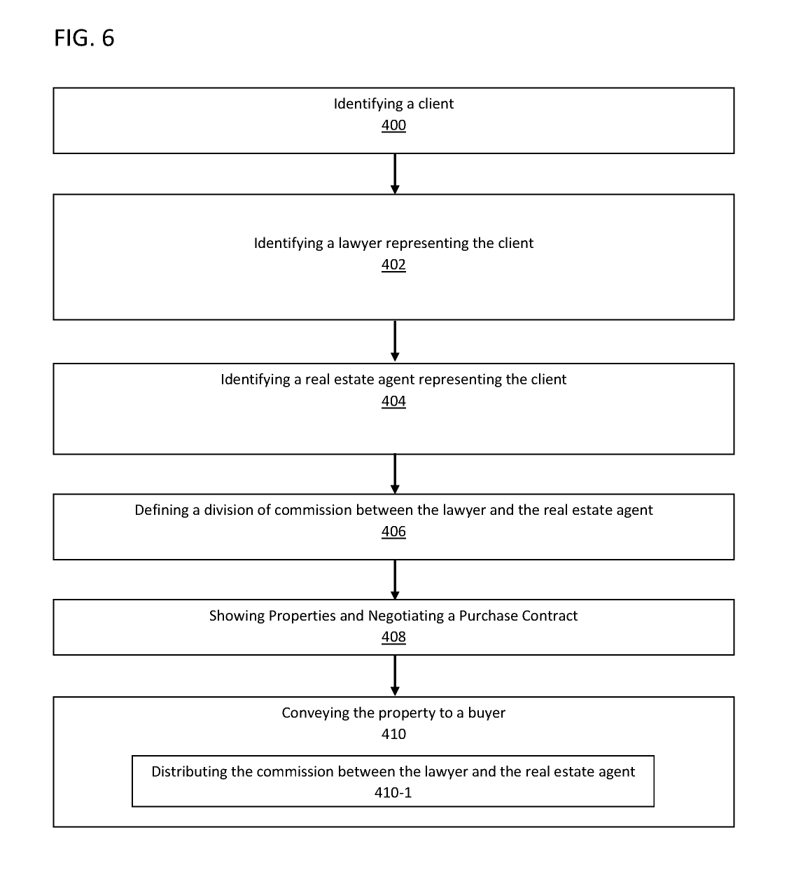

FIG. 6 illustrates an exemplary series of operations according to an embodiment of the present invention. FIG. 6 is similar to FIG. 4 except it provides a series of operations for a property transaction associated with a purchaser. The first operation 400 of FIG. 2 comprises identifying a client 302. Client 302 is a purchaser that wishes to purchase a property.

The second operation 402 comprises identifying a lawyer 306 representing client 302. Client 302 may enter into a attorney-client relationship 310 with lawyer 306 to represent client 302. In one aspect of the invention, in forming relationship 310, client 302 may desirably retain and/or provide lawyer 306 with the authority to represent and act on behalf of client 302 for the purpose of taking all necessary and prudent steps to purchase and transfer a property, including showing properties, making offers for the purchase of a property on behalf of the client 302, and acting on the client's 302 behalf with sellers and their lawyers or agents. In one embodiment, client 302 may also provide instructions that lawyer 306 may share its commission with a real estate agent 304. In an exemplary such embodiment, client 302 may authorize lawyer 306 to permit real estate agent 304 to perform some of the tasks involved in the purchasing of a property such as locating and showing various properties to the client 302, for example. In some embodiments, lawyer 306 may be given the option to perform all the tasks involved in representing the client 302 in purchasing a property without the assistance of a real estate agent 304. Typically, operation 402 may desirably comprise executing a retainer agreement, such as a written agreement or electronically represented written agreement between the client 302 and lawyer 306 which defines the tasks to be completed in association with the purchase of a property, and further defining the remuneration to be paid to the lawyer 306 for such services.

In one such embodiment, operation 402 further comprises defining an agreement whereby client 302 agrees to provide lawyer 306 with the buyer agent portion of a commission fee provided by the seller, such as is paid by a seller to the listing real estate agent. In some embodiments, client 302 may provide instructions that lawyer 306 may share its buyer agent fee with a real estate agent 304 for performing some of the tasks required to purchase a property.

In some embodiments, relationship 310 may desirably provide that lawyer or law firm 306 may only exclusively represent one party in the transaction associated with the purchase of the property. That is, lawyer 306 may only represent purchaser client 302, and may not form or have a pre-existing relationship, such as a limited dual agency relationship for example, with a seller.

In some embodiments, relationship 310 may be formalized in the form of a purchaser agent fee agreement, retainer agreement, contract or other legal agreement, such as in the form of a written agreement or electronically represented written agreement, between lawyer 306 and client 304. These agreements providing the agreed to terms and conditions of relationship 310, including the commission to be paid to the lawyer 306 for services associated with the purchase of the property.

The third operation 404 of FIG. 6 comprises identifying real estate agent 304 representing the client 302. In one embodiment, identifying a real estate agent 304 representing the client 302 comprises a client 302 and real estate agent 304 entering into an agency relationship 308. In some embodiments, identifying real estate agent 304 comprises lawyer or law firm 306 searching a realtor database for realtors willing to form a relationship 112 with the lawyer 306. In some embodiments, client 302 may know a real estate agent 304 that is willing to engage in a relationship 312 with the lawyer 306 for cooperatively providing services associated with purchase of a property.

In one such embodiment, operation 404 further comprises defining the remuneration to be paid to the real estate agent 304 for the provision of services in the purchase of a property. In a preferred embodiment, real estate agent 304 agrees to be paid a buyer agent commission fee offered by the listing agent, which fee is then shared with lawyer 306. In one such embodiment, the division of the buyer agent commission fee and amount to be paid to each of the real estate agent 304 and lawyer 306 is determined by the fourth operation 306 and is defined in the relationship 312 between the real estate agent 304 and lawyer 306.

In some embodiments, relationship 308 will provide that real estate agent 304 may only exclusively represent one party in the transaction associated with the sale of the property. That is, real estate agent 304 may only represent client 302, and may not form a relationship, such as a limited dual agency relationship, with a seller.

The fourth operation 406 comprises defining a division of commission, or commission sharing terms, between the lawyer 306 and the real estate agent 304. Lawyer 306 and real estate agent 304 may typically negotiate and define a division of commission, or commission sharing term, such as to form the basis of relationship 312. In some embodiments, the division of commission or commission sharing terms may comprise a fixed sum to be paid to at least one of the lawyer 306 and real estate agent 304. In some embodiments, the division of commission or commission sharing term may comprise a percentage of the buyer agent commission fee payable to lawyer 306 upon purchase of the property and defined in relationship 310 between the lawyer 306 and client 302.

In some embodiments, a division of commission or commission sharing terms may further comprise lawyer 306 and real estate agent 304 dividing a series of required or optional tasks associated with the purchase of property between themselves. In one such embodiment, the division of tasks may be based on the division of the buyer agent commission fee. In one embodiment, an exemplary, non-limiting, series of tasks associated with the purchase of a property that may be divided between the lawyer 306 and real estate agent 304 may comprise:
Obtaining property parameters from the client;
Placing client on automatic MLS® or other listing notification system based on the property parameters;
Showing the client various properties they are interested in;
Completing a land title or other property registry or records office search and reviewing with client;
Obtaining client instruction and drafting purchase offer with appropriate subject conditions;
Negotiating counter-offers with the seller on behalf of client;
Diarizing subject removal date;
Providing the client with mortgage broker information;
Obtaining a property disclosure or similar statement;
Drafting subject removal addendum; and
Obtaining deposit money from client and placing in trust account.

In one embodiment, the real estate agent 304 may perform the tasks of obtaining property parameters from the client, placing client on automatic MLS notification system based on the property parameters and showing the client various properties they are interested in. In an exemplary such embodiment, the realtor's 304 share of the buyer agent commission fee may comprise between approximately 60-90% of the total buyer agent commission fee. In one such embodiment, the remainder of the tasks associated with a real estate property transaction would be performed by the lawyer or law firm 106, with the lawyer 106 receiving the remainder of the commission, such as between approximately 10-40% of the total buyer agent commission fee, for example.

In some embodiments relationship 312 may be formalized between lawyer 306 and real estate agent 304 through an engagement agreement, contract, or other legal document, such as in the form of a written agreement or electronically represented written agreement, which may desirably define the division of commission remuneration and tasks between the lawyer 306 and real estate agent 304.

Although the second 402, third 404 and fourth 406 operations have been presented in a sequential order in the exemplary embodiment illustrated in FIG. 4, the order of each operation is non-essential to the practice of the invention. In other embodiments, each of operations 402, 404, 406 may occur before or after one another. In some embodiments, operations 402, 404, 406 may commence concurrently. In some embodiments, the fourth operation 406 (defining division of commission or commission sharing terms) and relationship 312 may exist prior to client 302 deciding to purchase a property and before the first exemplary operation 400.

The fifth operation 408 comprises showing properties. In one embodiment, showing properties may typically comprise the lawyer 306 and/or real estate agent 304 performing the series of tasks that each previously agreed to in accordance with the fourth operation 406, in association with locating a property for purchase and negotiating the purchase of a property. The fifth operation 408 may typically be completed when client 302 has executed a purchase and sale agreement with a seller. In one embodiment, at such point the purchase and sale agreement may desirably be ready for conveyancing.

The sixth operation 410 comprises conveying the property to the purchaser. In one embodiment, conveying the property to the purchaser may typically comprise at least one or more of:
Awaiting conveyancing instruction letter;
Preparing closing documents, including mortgage documents;
Liaising with the seller's lawyer;
Acting as escrow agent;
Arranging title insurance and/or liaising with title companies
Attending to execution of closing documents;
Depositing remainder balance of funds require to complete transaction into trust account;
Registration or recordal of property title documents in a land title registry or other property records office; and
Arranging for the pick-up of keys and title documents by client.

In some embodiments, fifth operation 410 may additionally comprise operation 410-1 which comprises distributing the buyer's agent commission between the lawyer 306 and real estate agent 304. In one such embodiment, the buyer's agent commission may be distributed according to the division of commission or commission sharing terms defined in operation 406 as part of relationship 312 between the lawyer 306 and real estate agent 304, for example.

While the present invention and its various functional components and operational functions have been described in particular exemplary embodiments, the invention may also be implemented in electronic and/or computer hardware, software, firmware, middleware or a combination thereof and utilized in electronic and/or computerized systems, subsystems, components or subcomponents thereof. In particular embodiments implemented in software, elements of the present invention may be instructions and/or code segments to perform the necessary tasks. The program or code segments may be stored in a machine readable medium, such as an exemplary non-transitory computer readable medium, such as may comprise a processor readable medium, such as a processor readable storage medium or a computer program product, or transmitted by a computer data signal embodied in a carrier wave, or a signal modulated by a carrier, over a transmission medium or communication link. The machine readable medium or processor readable medium may include any non-transitory medium that can store or transfer information in a form readable and executable by a machine, for example a processor, computer, etc.

An embodiment of the present invention relates to a computer storage product with a non-transitory computer-readable medium having computer code thereon for performing various computer-implemented operations. The computer-readable media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (“ASICs”), programmable logic devices (“PLDs”) and ROM and RAM devices including Flash RAM memory storage cards, sticks and chips, for example. Examples of computer code include machine code, such as produced by a compiler, and files containing higher-level code that are executed by a computer using an interpreter. For example, an embodiment of the invention may be implemented using HTML, HTML5, XML, JavaScript, Java, C#, C++, Objective C, or other scripting, markup and/or programming languages and development tools. Another embodiment of the invention may be implemented in hardwired circuitry in place of, or in combination with, machine-executable software instructions.

In an alternative embodiment, aspects of the present invention may be implemented in written or other non-volatile recorded form, such as in implementations and applications using printed and/or written documents, forms, checklists and the like.

The exemplary embodiments herein described are not intended to be exhaustive or to limit the scope of the invention to the precise forms disclosed. They are chosen and described to explain the principles of the invention and its application and practical use to allow others skilled in the art to comprehend its teachings.

As will be apparent to those skilled in the art in light of the foregoing disclosure, many alterations and modifications are possible in the practice of this invention without departing from the scope thereof. Accordingly, the scope of the invention is to be construed in accordance with the substance defined by the following claims.

What is claimed is:

1. A method of real estate brokerage, the method comprising:
identifying a client, the client owning a property;
identifying a lawyer representing the client;
identifying a real estate agent representing the client;
defining a division of a commission payable on sale of the property between the lawyer and the real estate agent;
promoting the sale of the property, and negotiating a sale contract, by at least one of the lawyer and the real estate agent based on the division of the commission;
conveying the property to a buyer by the lawyer; and
distributing the commission between the lawyer and the real estate agent according to the division.

2. The method according to claim 1, wherein identifying a lawyer representing the client comprises executing a retainer agreement between the client and the lawyer.

3. The method according to claim 1, wherein identifying a real estate agent representing the client comprises executing an agency agreement between the client and the real estate agent.

4. The method according to claim 1 where promoting the sale of the property comprises a plurality of tasks associated with the sale of the property.

5. The method according to claim 4, wherein defining a division of a commission payable on sale of the property additionally comprises defining a division of said plurality of tasks between the lawyer and the real estate agent.

6. The method according to claim 5, wherein defining a division of said plurality of tasks is based on the division of the commission between the lawyer and the real estate agent.

7. The method according to claim 1, wherein conveying the property to a buyer by the lawyer comprises a plurality of tasks comprising one or more of: reviewing title records for the property; conducting a title search for charges against the property;
preparing property transfer documents; effecting execution of property transfer documents by at least one of the seller and the purchaser; ordering funds from a lender;
effecting deposit of funds from at least one of a lender and purchaser; filing property transfer documents in a property registry; acting as escrow agent; arranging for title insurance; liaising with title companies; and discharging one or more of a mortgage, lien or liability against the property.

8. The method according to claim 4, wherein the plurality of tasks associated with the sale of the property comprises one or more of: determining an asking price for the property; marketing the property; listing the property with a property listing service;
showing the property to a prospective purchaser; reviewing a title document to the property; reviewing an offer for the sale and purchase of the property from a prospective purchaser; advising the client regarding an offer for sale and purchase; and receiving trust money from a prospective purchaser.

9. A method of real estate brokerage, the method comprising:
identifying a client, the client purchasing a property;
identifying a lawyer representing the client;
identifying a real estate agent representing the client;
defining a division of a commission payable on purchase of the property between the lawyer and the real estate agent;
showing the property, and negotiating a purchase contract, by at least one of the lawyer and the real estate agent based on the division of the commission;
conveying the property to the client by the lawyer; and
distributing the commission between the lawyer and the real estate agent according to the division.

10. The method according to claim 9, wherein identifying a lawyer representing the client comprises executing a retainer agreement between the client and the lawyer.

11. The method according to claim 9, wherein identifying a real estate agent representing the client comprises executing an agency agreement between the client and the real estate agent.

12. The method according to claim 9 where showing the property comprises a plurality of tasks associated with the purchase of the property.

13. The method according to claim 12, wherein defining a division of a commission payable on sale of the property additionally comprises defining a division of said plurality of tasks between the lawyer and the real estate agent.

14. The method according to claim 13, wherein defining a division of said plurality of tasks is based on the division of the commission between the lawyer and the real estate agent.

15. The method according to claim 9, wherein conveying the property to the client by the lawyer comprises a plurality of tasks comprising one or more of: receiving a conveyancing instruction letter; preparing closing documents; effecting execution of closing documents; effecting deposit of purchase funds into a trust account; and effecting distribution of keys and/or title documents to the client.

16. The method according to claim 12, wherein the plurality of tasks associated with the purchase of the property comprises one or more of: determining property requirements from the client; completing a search of a property listing service based on property parameters; showing a property to the client; completing at least one of a land title or other property registry search for the property; drafting a purchase offer; negotiating a counter-offer with the seller on behalf of the client; arranging for subject removals; providing the client with mortgage broker information; obtaining a property disclosure statement from the seller; and effecting deposit of money from client in a trust account.

17. A non-transitory computer-readable medium storing computer-executable instructions to implement a method of real estate brokerage, comprising computer-executable instructions to:
identify a client, the client owning or purchasing a property;
identify a lawyer representing the client;
identify a real estate agent representing the client;
define a division of a commission payable on at least one of sale or purchase of the property between the lawyer and the real estate agent;
promote or show the property, and negotiate a purchase contract, by at least one of the lawyer and the real estate agent based on the division of the commission;
convey the property to a buyer of the property by the lawyer; and
distribute the commission between the lawyer and the real estate agent according to the division.

18. The non-transitory computer-readable medium according to claim 17, wherein the client is purchasing the property, and wherein the buyer of the property is the client.

19. The non-transitory computer-readable medium according to claim 17, wherein the computer-executable instructions to identify a lawyer representing the client comprise instructions to generate a retainer agreement document and recording execution of the retainer agreement document.

20. The non-transitory computer-readable medium according to claim 17, wherein the computer-executable instructions to identify a real estate agent representing the client comprise instructions to generate an agency agreement document and recording execution of the agency agreement document.

21. The non-transitory computer-readable medium according to claim 17, wherein the computer-executable instructions to identify a real estate agent representing the client comprise instructions to generate an engagement agreement document between the lawyer and real estate agent, and recording execution of the engagement agreement document.
